(19) United States
(12) Patent Application Publication
(10) Pub. No.: US 2024/0341244 A1
(43) Pub. Date: Oct. 17, 2024

(54) CULTIVATION DATA MANAGING PLATFORM AND MANAGING METHOD USING DYNAMIC OUTPUT FUNCTION

(71) Applicant: KOREA DIGITAL CO., LTD., Seoul (KR)

(72) Inventors: Bong-Min KIM, Seoul (KR); Yu-Jin YUN, Seoul (KR)

(73) Assignee: KOREA DIGITAL CO., LTD., Seoul (KR)

(21) Appl. No.: 18/292,677

(22) PCT Filed: Jul. 29, 2022
(86) PCT No.: PCT/KR2022/011189

§ 371 Date: Jan. 26, 2024

(30) Foreign Application Priority Data
Jul. 29, 2021 (KR) 10-2021-0099747

(51) Int. Cl. A01G 9/24; G06Q 50/02

(52) U.S. Cl. CPC A01G 9/24; G06Q 50/02

(57) ABSTRACT

Disclosed are a cultivation data managing platform and a managing method using a dynamic output function. The present invention can generate a plant cultivation recipe on the basis of plant cultivation data and control data by using a communication application, and trade and distribute the generated plant cultivation recipe.

### TECHNICAL FIELD

The present disclosure relates to a cultivation data managing platform and a managing method using a dynamic output function and, more specifically, to a cultivation data managing platform and a managing method using a dynamic output function, which may generate a plant cultivation recipe on the basis of plant cultivation data and control data by using a community application and trade and distribute the generated plant cultivation recipe.

### BACKGROUND ART

A smart farm refers to a crop cultivation system designed to use technologies such as the Internet of Things, big data, and artificial intelligence to appropriately maintain and manage crop growth environments, and remotely and automatically manage same by means of PCs and smartphones so as to increase convenience as well as efficiency.

The smart farm may enable precise management and prediction for each growth stage on the basis of accurate data on environmental condition data (temperature, relative humidity, light amount, carbon dioxide, soil, and the like) and growth information through an ICT technology, thus improving yield and quality to increase profitability.

By way of example, the smart farm includes hardware including an air conditioning device for adjusting the temperature and a sprayer for adjusting the humidity inside a greenhouse, an injector for periodically supplying dissolved fertilizer or a shading device for adjusting an amount of sunlight, and an irrigation device for supplying water, and a terminal automatically operating the hardware according to a program installed therein.

Furthermore, the terminal includes a PC, a portable terminal (smartphone or tablet PC), or the like, and the terminal operates the hardware to automatically control temperature, humidity, amount of sunlight, and fertilizer supply amount, or irrigation to achieve optimal conditions, thereby improving productivity.

However, there is a problem in that the optimization is attempted to be achieved only with knowhow possessed by each farm, thus there is a limit to the improvement of product quality and productivity and the like.

In addition, the knowhow is a farming technology that utilizes data of the optimal environment (temperature, humidity, amount of sunlight, type of fertilizer, amount of fertilizer supplied, and the like), and it is kept confidential by a farm family that developed the technology, and thus further technological development may not be expected.

However, if the knowhow is possessed by various farm families and improved to suit each environment, it will be possible to improve product quality and productivity by adding ideas from each farm.

Furthermore, when plants are cultivated using the same plant cultivation device, there may be a problem in that a main goal is focused on productivity rather than quality since control is based on a general growth environment of crops without considering regional characteristics, and thus reasonable profits may not be generated.

### DISCLOSURE OF INVENTION

### Technical Problem

To address the problem, an aspect of the present disclosure provides a cultivation data managing platform and a managing method using a dynamic output function, which may generate a plant cultivation recipe on the basis of plant cultivation data and control data by using a community application and trade and distribute the generated plant cultivation recipe.

### Solution to Problem

To this end, an embodiment of the present disclosure provides a cultivation data managing platform using a dynamic output function, the platform including a cultivation managing platform server which provides a cultivation recipe to a cultivation device that develops a cultivation environment and manages a growth state of a plant, wherein the cultivation managing platform sever generates a plant cultivation algorithm for each crop and optimizes the cultivation algorithm suitable for a purpose of each plant crop, and if a plant cultivation algorithm for each crop in a non-optimized state is optimized, manages the algorithm as a cultivation recipe that may be distributed to the cultivation device, the plant cultivation algorithm for each crop generates a changed cultivation recipe by actively responding to variables through dynamic output function characteristics that dynamically change according to input variables including a surrounding situation and environment, and the plant cultivation algorithm for each crop extracts an effective procedure for cultivation through recipe complexity calculation to control an input and output of the cultivation device operated by the recipe in a finite state, performs fine adjustment of the recipe and modification of the effective procedure through feedback from the cultivation device, and changes the finite state of the cultivation device, the finite state including a state without a recipe, a state finely adjusted by the algorithm, and a state of the effective procedure modified through feedback from the cultivation device, which is generated by stimulation of real-time metadata.

Furthermore, the cultivation managing platform server according to the embodiment provides a cultivation recipe basically configured in the cultivation device for developing a cultivation environment and managing a growth state of a plant, but when an individual cultivation recipe generated by any other user using the cultivation device is provided, provides, to a user terminal, function configuration information for controlling an operation of the cultivation device, usage configuration information, and operation information, and controls the cultivation device to develop the cultivation environment and manage the growth state of a plant according to the provided individual cultivation recipe.

In addition, the user terminal according to the embodiment changes the cultivation recipe configured in the cultivation device to a corrected cultivation recipe to which consulting data and control data are reflected on the basis of the individual cultivation recipe generated by other predetermined user and the cultivation recipe through trade or distribution and controls an operation of the cultivation device.

In addition, the cultivation managing platform server according to the embodiment shares, when at least one of exchanging information on a cultivation recipe with other users or experts invited to a chat room for a cultivation recipe community through the user terminal, receiving a cultivation recipe, and correcting a cultivation recipe is performed, a cultivation recipe to which a performance result has been reflected, and controls the cultivation device to develop a cultivation environment and manage growth state of a plant according to the cultivation recipe to which the performance result has been reflected.

In addition, the cultivation managing platform server according to the embodiment provides, when a corrected cultivation recipe generated by an expert terminal is provided, the function configuration information of the cultivation device, the usage configuration information, and the operation information to the expert terminal, and controls the cultivation device to develop the cultivation environment and manage the growth state of a plant according to consulting data and control data from the expert terminal.

In addition, the cultivation managing platform server according to the embodiment includes a member managing part configured to manage authentication information of a user using the cultivation device and authentication information of an expert using the expert terminal for generating the corrected cultivation recipe, and the member managing part configures, while consulting data and control data are input by the expert terminal approved for a predetermined cultivation recipe, a corresponding expert terminal to have management authority for the cultivation recipe.

In addition, the corrected cultivation recipe according to the embodiment is generated by reflecting expert information, a change history, and a tag based on the consulting data and control data input to the expert terminal to allow the user to identify whether the corresponding data is corrected or applied by referring to the expert information, the change history, and the tag.

In addition, the cultivation managing platform server according to the embodiment performs a change to a corrected cultivation recipe to which the consulting data and control data input from the expert terminal have been reflected on the basis of a cultivation recipe of the cultivation device stored in a database when there is a request from the user terminal in the chat room, and controls an operation of the cultivation device by using the changed cultivation recipe.

In addition, the cultivation managing platform server according to the embodiment enables co-cultivation by linking cultivation device 1 to cultivation device n when a user terminal requests same together with terminal 1 to terminal n of other multiple users through the chat room.

In addition, the cultivation managing platform server according to the embodiment manages an expert terminal to invite a specific user among user terminals to a chat room for a community to share a cultivation recipe thereof according to consulting or to control a cultivation device managed by the corresponding user terminal.

In addition, the cultivation managing platform server according to the embodiment allows an expert terminal to invite multiple user terminals, terminal 1 to terminal n, to a chat room generated by a community managing part and perform co-cultivation by linking a cultivation recipe thereof to cultivation device 1 to cultivation device n.

In addition, the cultivation managing platform server according to the embodiment links a cultivation recipe provided by a predetermined expert terminal from among an expert terminal, and expert terminal 1 to expert terminal n with a cultivation device, and cultivation device 1 to cultivation device n in the generated chat room for the community so as to be used for co-cultivation or joint research.

In addition, the cultivation managing platform server according to the embodiment performs optimization of the cultivation algorithm by using collaboration of experts through the generated chat room for the community and manages the optimized cultivation algorithm.

In addition, the cultivation managing platform server according to the embodiment links the cultivation device, and cultivation device 1 to cultivation device n and manages each expert to collaborate to perform optimization of a cultivation algorithm suitable for a purpose of each crop through environment control with respect to a plant cultivation algorithm for each crop posted in the chat room by a predetermined expert.

In addition, the cultivation managing platform server according to the embodiment manages a cultivation recipe and a plant cultivation algorithm for each crop for the entire cultivation cycle for each cultivated plant and when a predetermined cultivation recipe is traded or distributed, controls and manages a cultivation device from a beginning of cultivation to a harvesting in the cultivation device according to the corresponding cultivation recipe.

In addition, the cultivation managing platform server according to the embodiment synchronizes, in case that a cultivation recipe or a plant cultivation algorithm for each crop is traded or distributed and cultivation is performed in a cultivation device, data on the number of days of cultivation in the corresponding cultivation device with cropping schedule from metadata of the traded cultivation recipe or cultivation algorithm so that safe cultivation is performed in the cultivation device for a predetermined period from a time point at which the recipe is traded or distributed or until cultivation is completed even during a cropping season of plant cultivation.

In addition, the cultivation managing platform server according to the embodiment generates a predetermined chat room for a cultivation recipe community, manages the individual cultivation recipe and the corrected cultivation recipe to be traded or distributed by allowing the user terminal to perform chatting and a predetermined payment procedure with user terminal 1 to user terminal n and the expert terminal through the chat room, and enables sensor data measured by the cultivation device and control data for control to be periodically displayed or to be displayed whenever an event occurs, in a chat room automatically generated for each cultivation device.

The automatically generated chat room according to the embodiment is configured to enable inviting a predetermined user or expert according to a request of a user terminal or an expert terminal.

In addition, an embodiment according to the present disclosure relates to a managing method using a cultivation managing platform server which provides a cultivation recipe to a cultivation device that develops a cultivation environment and manages a growth state of a plant, wherein the cultivation managing platform sever generates a plant cultivation algorithm for each crop and optimizes a cultivation algorithm suitable for a purpose of each plant crop, and if a plant cultivation algorithm for each crop in a non-optimized state is optimized, manages the algorithm as a cultivation recipe that may be distributed to the cultivation device, the plant cultivation algorithm for each crop generates a changed cultivation recipe by actively responding to variables through dynamic output function characteristics that dynamically change according to input variables including a surrounding situation and environment, and the plant cultivation algorithm for each crop extracts an effective procedure for cultivation through recipe complexity calculation to control an input and output of the cultivation device operated by the recipe in a finite state, performs fine adjustment of the recipe and modification of the effective procedure through feedback from the cultivation device, and changes the finite state of the cultivation device, the finite state including a state without a recipe, a state finely adjusted by the algorithm, and a state of the effective procedure modified through feedback from the cultivation device, which is generated by stimulation of real-time metadata.

In addition, the managing method using the cultivation managing platform according to the embodiment include a) an operation in which the cultivation managing platform server performs member registration and authentication of a user and an expert accessing through a user terminal for controlling an operation of the cultivation device and an expert terminal for generating the corrected cultivation recipe, respectively; b) an operation in which the authenticated user terminal generates a chat room for a cultivation recipe community linked with the cultivation device through the cultivation managing platform server and requests an invitation to a predetermined expert terminal; c) an operation in which the cultivation managing platform server transmits an invitation message to the expert terminal and according to identifying access of the expert terminal to the chat room, the user terminal uploads a cultivation recipe of the cultivation device configured in the cultivation device; d) an operation in which the expert terminal inputs predetermined consulting data and control data to the uploaded cultivation recipe of the cultivation device to generate a corrected cultivation recipe, when approval of the corrected cultivation recipe is identified from the user terminal, the cultivation managing platform server manages trade or distribution of the corrected cultivation recipe to be performed through a predetermined payment procedure between the user terminal and the expert terminal, and the user terminal reflects the corrected cultivation recipe as a new cultivation recipe to operate the cultivation device; and e) an operation in which the cultivation managing platform server receives consulting data or control data with respect to values of metadata from the expert terminal generating the corrected cultivation recipe through the chat room in a state of displaying a library expanded to be input for each metadata, the library being used in the cultivation device while being included in the cultivation recipe by a request of the user terminal using the cultivation device.

In addition, the managing method using the cultivation managing platform according to the embodiment may further include a′) an operation in which the authenticated user terminal generates a chat room for a cultivation recipe community linked with the cultivation device through the cultivation managing platform server and requests an invitation to predetermined user terminal 1; b′) an operation in which the cultivation managing platform server transmits an invitation message to user terminal 1, identifies access of user terminal 1 to the chat room, and performs trade of an individual cultivation recipe of cultivation device 1 managed by user terminal 1 between the user terminal and user terminal 1 according to a request of the user terminal; and c′) an operation in which the user terminal reflects the individual cultivation recipe of cultivation device 1 as a new cultivation recipe of the cultivation device and controls the cultivation device to operate.

### Advantageous Effects of Invention

The present disclosure is advantageous in that the present disclosure can generate a plant cultivation recipe on the basis of plant cultivation data and control data by using a communication application, and trade and distribute the generated plant cultivation recipe.

In addition, the present disclosure is advantageous in that the present disclosure may allow various plant cultivation recipes to be provided, traded, and distributed through activity using a community application so as to expand the distribution of plant cultivation devices.

In addition, the present disclosure may actively cope with dynamically changing variables through a process of optimizing the plant cultivation algorithm for each crop in that not only cultivation recipes can be traded and distributed, but also plant cultivation algorithms for each crop can be traded and distributed.

The distribution of various plant cultivation devices including devices for education and practice, a mass production business, and an expert may be expanded according to a purpose of use.

In addition, the present disclosure is advantageous in that the present disclosure can increase productivity and effective use of the plant cultivation devices through the provision, trade, and distribution of various plant cultivation recipes.

In addition, it is expected to achieve an effect of lowering barriers to entry in agriculture to broaden a foundation for future food crop production, and to improve accessibility to a platform familiar to and in tune with an Internet generation so as to contribute to expanding the base of agriculture and agriculture-based industries.

In addition, the present disclosure is advantageous in that the know-how of agricultural experts can be widely shared through the plant cultivation devices, thereby improving the level of the agricultural society as a whole.

### BRIEF DESCRIPTION OF DRAWINGS

FIG. 1 is a block diagram illustrating a configuration of a cultivation data managing platform using a dynamic output function according to an embodiment of the present disclosure.

FIG. 2 is a block diagram illustrating a configuration of a cultivation data managing platform server of a cultivation data managing platform using a dynamic output function according to the embodiment of FIG. 1.

FIG. 3 is a flowchart illustrating a managing method of a cultivation data managing platform using a dynamic output function according to an embodiment of the present disclosure.

FIG. 4 is a flowchart illustrating a library modification process by an expert in a managing method of a cultivation data managing platform using a dynamic output function according to the embodiment of FIG. 3.

FIG. 5 is a flowchart illustrating a trade process of a plant cultivation recipe in a managing method of a cultivation data managing platform using a dynamic output function according to the embodiment of FIG. 3.

### BEST MODE FOR CARRYING OUT THE INVENTION

Hereinafter, the present disclosure will be described in detail with reference to preferred embodiments of the present disclosure and accompanying drawings, and in the drawings, like reference numerals refer to like elements throughout.

Prior to describing detailed contents for carrying out the present disclosure, it should be noted that a configuration not directly associated with the technical gist of the present disclosure is omitted without departing from the technical gist of the present disclosure.

Further, terms or words used in the present specification and claims should be interpreted as meanings and concepts which match the technical spirit of the present disclosure based on a principle in which the inventor can define appropriate concepts of the terms in order to describe his/her invention using a best method.

Throughout the disclosure, when it is described that a part “includes” a certain element, it should be understood that the part may include other elements as well, rather than excluding other elements, unless specifically described otherwise.

In addition, terms such as “ . . . part”, “ . . . unit”, and “ . . . module” refer to units that process at least one function or operation, which may be classified as hardware, software, or a combination thereof.

In addition, it is obvious that the term “at least one” is defined as a term including a singular form and a plural form and even though the term “at least one” is not used, each component may be provided as a singular form or a plural form and it means a singular form or a plural form.

Further, each component may be provided as a singular form or a plural form depending on the exemplary embodiments.

Hereinafter, a preferred embodiment of a cultivation data management platform and managing method using a dynamic output function according to an embodiment of the present disclosure will be described in detail with reference to the accompanying drawings.

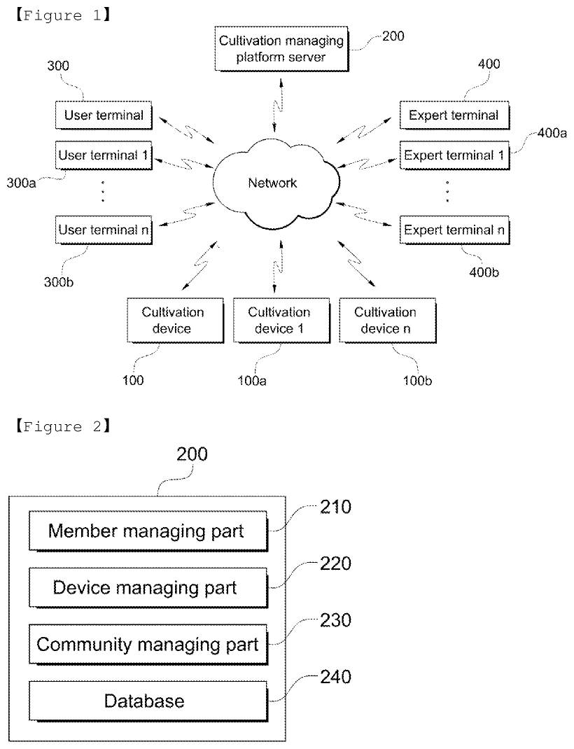

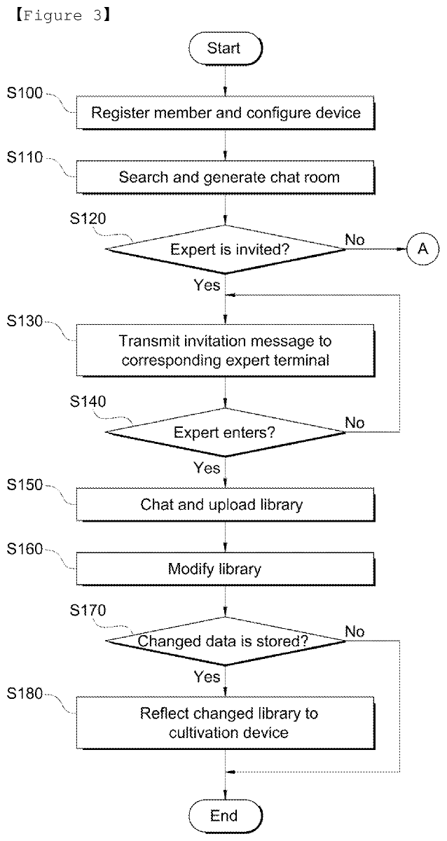

FIG. 1 is a block diagram illustrating a configuration of a cultivation data managing platform using a dynamic output function according to an embodiment of the present disclosure, and FIG. 2 is a block diagram illustrating a configuration of a cultivation data managing platform server of a cultivation data managing platform using a dynamic output function according to the embodiment of FIG. 1.

Referring to FIGS. 1 and 2, the cultivation data managing platform using a dynamic output function according to an embodiment of the present disclosure may generate a plant cultivation recipe based on cultivation data and control data of a plant and may be configured by including a cultivation device 100, a cultivation managing platform server 200, a user terminal 300, and an expert terminal 400 to enable trade and distribution of the generated plant cultivation recipe.

The cultivation device 100 may include a sensor for measuring plant cultivation environment data, and may be configured to develop a cultivation environment and manage a growth state of a plant, and may operate to cause the cultivation environment to be developed and the growth state of a plant to be managed on the basis of one of a cultivation recipe, an individual cultivation recipe, and a corrected cultivation recipe configured by the cultivation managing platform server 200 or the user terminal 300.

In addition, although the present embodiment is described based on one cultivation device 100, the present disclosure is not limited thereto, and it is obvious to those skilled in the art that the present disclosure may be changed and realized to include cultivation device 1 100a to cultivation device n 100b for developing a cultivation environment and managing a growth state of another plant in addition to the cultivation device 100. Accordingly, mass production is also possible through joint cultivation through cultivation device 1 100a to cultivation device n 100a by multiple users applying therefor.

The cultivation managing platform server 200 provides a cultivation recipe to the cultivation device 100, and generates and manages a cultivation recipe community to allow one of an individual cultivation recipe generated by a predetermined user or a corrected cultivation recipe to which predetermined consulting data and control data have been reflected to be traded or distributed among users.

In addition, the cultivation managing platform server 200 may manage a cultivation recipe or a plant cultivation algorithm for each crop to be traded or distributed among users.

In addition, the cultivation managing platform server 200 manage generation of a chat room requested by the user terminal 300 or the expert terminal 400 for a cultivation recipe community, invitation of a user or an expert, chatting among users, chatting among experts, and the like to be performed.

In addition, the cultivation managing platform server 200 may perform a preconfigured payment process when trade or distribution of an individual cultivation recipe between the user terminal 300 and a user, for example, user terminal 1 300a is requested.

In addition, the cultivation managing platform server 300 may perform a payment process when a trade or distribution of a corrected cultivation recipe to which consulting data and control data have been reflected between the user terminal 300 and the expert terminal 400 is requested, and may be configured by including a device managing part 220, a community managing part 230, and a database 240.

The member managing part 210 may correspond to a component for managing authentication information of a user and an expert, and users may be divided into users having and using the cultivation device 100 and users not having the cultivation device 100.

The device managing part 220 provides, to the cultivation device 100, a cultivation recipe, an individual cultivation recipe, and a corrected cultivation recipe to manage a growth state and develop a cultivation environment of a plant.

The device managing part 220 provides and manages a function configuration with respect to the cultivation device 100, and cultivation device 1 100a to cultivation device n 100b, usage description information, and a cultivation recipe configured for each corresponding cultivation device.

The cultivation recipe includes a plant cultivation recipe generated based on control-related data and plant cultivation data collected from various sensors installed in the cultivation device 100.

The cultivation recipe may include a cultivation recipe for automatically controlling a temperature, humidity, amount of sunlight, fertilizer supply amount, or irrigation of the cultivation device 100 to artificially generate stress on plant growth and extract a secondary metabolite for a purpose of using a plant cultivated in the cultivation device as a cosmetic product and an anti-aging drug.

In addition, the device managing part 220 may allow the user terminal 300 to invite another predetermined user or expert to a chat room for a community generated by the community managing part 230 so as to exchange information about a cultivation recipe, receive an individual cultivation recipe, or perform correction of a cultivation recipe and store a result thereof in the database 240.

The device managing part 220 may allow the user terminal 300 to send an invitation message to a specific user, for example, user terminal 1 300a among user terminal 1 300a to user terminal n 300b through the community managing part 230 so as to invite the user to the chat room.

In addition, the device managing part 220 allow the user terminal 300 to send an invitation message to one or more experts among the expert terminal 400 and expert terminal 1 400a to expert terminal n 400b to invite the one or more experts to a chat room for a community generated by the community managing part 230.

In addition, the device managing part 220 may change a cultivation recipe of the cultivation device 100 stored in the database to a cultivation recipe of cultivation device 1 100a stored in the database when the user terminal 300 achieves an approval of user terminal 1 300a in the chat room, and control an operation of the cultivation device 100 by using the changed cultivation recipe.

Here, the individual cultivation recipe stored in the database 240 may be configured to be protected through a block chain technology.

In addition, the device management part 220 may perform a change to a corrected cultivation recipe to which consulting data and control data input from, for example, the expert terminal 400 have been reflected on the basis of the cultivation recipe of the cultivation device 100 stored in the database when there is a request from the user terminal 300 in the chat room and control an operation of the cultivation device 100 by using the changed cultivation recipe.

Here, the device managing part 220 may receive consulting data or control data with respect to values of metadata from the expert terminal 400 in a state of displaying a library expanded to be input for each metadata, the library being used in the cultivation device 100 while being included in the cultivation recipe by a request of the user terminal in the chat room.

Here, the metadata may correspond to data measured by the cultivation device 100 and sensor data for control, and may include video data, audio data, text data, numerical data, and the like.

The metadata may correspond to, for example, various control data for automatically controlling the temperature, humidity, amount of sunlight, fertilizer supply amount, or irrigation of the cultivation device 100.

In addition, the device management part 220 may configure, when there is a request from the user terminal 300, the authenticated user terminal 400 to have a management authority of the cultivation recipe while the expert terminal 400 accessing the chat room inputs consulting data and control data to generate a corrected cultivation recipe.

Here, the device management part 220 generates a correction cultivation recipe by reflecting expert information, a change history, and a tag based on the consulting data and control data input by the expert terminal 400, and allow the user to identify whether the corresponding data is corrected and applied or the like after correction.

In addition, the device managing part 220 may enable, when the user terminal 300 makes a request together with multiple other user terminals including user terminal 1 300a to user terminal n 300b through a chat room, mass production by linking the cultivation device 100, and cultivation device 1 100a to cultivation device n 100b.

The device managing part 220 may allow the expert terminal 400 to invite another predetermined user or expert to a chat room for a community generated by the community managing part 230 so as to exchange information about a cultivation recipe, receive an individual cultivation recipe, or share a cultivation recipe and store a result thereof in the database 240.

The device managing part 220 may allow the expert terminal 400 to invite a specific user among user terminals through the community managing part 230 so as to share a cultivation recipe or to control a cultivation device managed by the corresponding user.

In addition, the device managing part 220 may allow the expert terminal 400 to invite multiple user terminals including the user terminal 230 and user terminal 1 100a to user terminal n 300b through the community managing part 230 and link a cultivation recipe thereof with the cultivation device 100, and cultivation device 1 100a to cultivation device n 100b so as to perform co-cultivation.

In addition, the device managing part 220 may allow the expert terminal 400 to invite one or more of other expert terminals to generate a chat room for configuring an expert community through the community managing part 230, like the case of the community configuration example of the user terminal 100.

In addition, the device managing part 220 may link a cultivation recipe provided by a predetermined expert terminal (one of 400, 400a, and 400b) from among the expert terminal 400 and expert terminal 1 400a to expert terminal n 400b in the chat room for the expert community generated by the community managing part 230 with the cultivation device 100 and cultivation device 1 100a to cultivation device n 100b so as to be used for a co-cultivation or joint research purpose.

Furthermore, the device managing part 220 may generate and manage a plant cultivation algorithm for each crop. The plant cultivation algorithm for each crop may be in a state not optimized yet and when optimized, the plant cultivation algorithm for each crop may be managed as a cultivation recipe.

The plant cultivation algorithm for each crop may have a dynamic output function characteristic that dynamically changes according to input variables such as a surrounding condition and an environment. The characteristic of the dynamic output function of the plant cultivation algorithm for each crop may allow an active response to variables actively changing through a process of optimizing the plant cultivation algorithm and thus achieve various changes of the cultivation recipe.

The plant cultivation algorithm for each crop may extract a valid procedure of cultivation through a recipe complexity calculation, control an input and an output of the cultivation device 100 operated by a recipe in a finite state, and perform, through feedback of the cultivation device 100, fine-tuning of a recipe, modification of the valid procedure, and change of the finite state of the cultivation device 100. The finite state of the cultivation device 100 may include, for example, a state without a recipe, a state finely tuned by an algorithm, and a state of a valid procedure modified through feedback of a cultivation machine generated by stimulation of real-time metadata.

When the plant cultivation algorithm for each crop is optimized to be a cultivation recipe, the device managing part 220 registers the cultivation recipe as a cultivation recipe distributable to the cultivation device 100 and manages same.

When the device managing part 220 attempts to distribute the cultivation recipe distributable through the community managing part 230 to the user terminal 100 to use same, the distribution may be performed through a legitimate payment method.

The device managing part 220 may perform optimization of the cultivation algorithm by using collaboration of experts through the chat room for the expert community generated by the community management part 230 and manage the optimized cultivation algorithm.

To this end, the device managing part 220 links the cultivation device 100, and cultivation device 1 100a to cultivation device n 100b and manages each expert to collaborate to perform optimization of a cultivation algorithm suitable for a purpose of each crop through detailed environment control with respect to a plant cultivation algorithm for each crop posted in the chat room by a predetermined expert.

The device managing part 220 may manage a cultivation recipe or a plant cultivation algorithm for each crop for the entire cultivation cycle for each cultivated plant.

That is, the device managing part 220 generates a cultivation recipe or a plant cultivation algorithm for each crop for the entire plant cultivation cycle, such as a seed management stage, a germination stage, a seedling stage, a stage from planting to harvest, and post-harvest management stage, and continuously manages same by reflecting a change in trade or distribution.

When a predetermined cultivation recipe is traded or distributed, the device managing part 220 controls and manages the cultivation device 100 from a stage in which cultivation starts in the cultivation device 100 to a harvest stage by using the corresponding cultivation recipe.

In case that cultivation is performed in the cultivation device 100 when a predetermined cultivation recipe is traded or distributed, the device managing part 220 may synchronize data with respect to the number of cultivation days in the corresponding cultivation device 100 and a cropping schedule from metadata of the traded cultivation recipe or cultivation algorithm.

As such, the device managing part 220 may ensure safe cultivation in the cultivation device 100 for a predetermined period from a time point at which the recipe is traded or distributed or until cultivation is completed even during a cropping season of plant cultivation.

The community managing part 230 manages a chat room according to a request of the user terminal 300 for a cultivation recipe community to be generated and deleted.

To this end, the community managing part 230 may generate a chat room for a cultivation recipe community according to a request of the user terminal 300 and the expert terminal 400.

The cultivation recipe community provides a known cultivation recipe and growth information related to the cultivation device 100 in a network communication network, and corresponds to a place where users may exchange various information and conversation using a screen.

In addition, the community managing part 230 manages a chat room generated according to a request of the user terminal 300 to allow user invitation or expert invitation, chatting among the user terminal 300 and user terminal 1 300a to user terminal n 300b, and chatting among the user terminal 300, and the expert terminal 400 and expert terminal 1 400a to expert terminal n 400b to be performed.

In addition, the community managing part 230 manages a preconfigured payment process and trade or distribution of an individual cultivation recipe to be performed between the user terminal 300 and, for example, user terminal 1 300a.

In addition, the community managing part 230 manages a preconfigured payment process and trade or distribution of a corrected cultivation recipe to which consulting data and control data have been reflected to be performed between the user terminal 300 and the expert terminal 400.

In addition, the community managing part 230 may generate a chat room for a cultivation recipe community according to a request of the user terminal 300, which may be used by the user terminal 300 to invite another predetermined user or expert to exchange information about a cultivation recipe, receive an individual cultivation recipe, or perform correction of a cultivation recipe and store a result thereof in the database 240.

To this end, the community managing part 230 may allow the user terminal 300 to send an invitation message to a specific user, for example, user terminal 1 300a among user terminal 1 300a to user terminal n 300b so as to invite the user to the chat room.

In addition, the community managing part 230 may allow the user terminal 300 to send an invitation message to one or more experts among the expert terminal 400 and expert terminal 1 400a to expert terminal n 400b to invite the one or more experts to a chat room for a cultivation recipe community.

In addition, the community managing part 230 may change a cultivation recipe of the cultivation device 100 stored in the database 240 to a cultivation recipe of cultivation device 1 100a stored in the database 240 through the device managing part 220 when the user terminal 300 achieves an approval of user terminal 1 300a in the chat room, and to control an operation of the cultivation device 100 by using the changed cultivation recipe.

Here, the individual cultivation recipe stored in the database 240 may be configured to be protected through a block chain technology.

In addition, the community management part 230 may perform a change to a corrected cultivation recipe to which consulting data and control data input from, for example, the expert terminal 400 have been reflected on the basis of the cultivation recipe of the cultivation device 100 stored in the database 240 through the device managing part 220 when there is a request from the user terminal 300 in the chat room and to control an operation of the cultivation device 100 by using the changed cultivation recipe.

Here, the community managing part 230 may allow consulting data or control data with respect to values of metadata to be input from the expert terminal 400 by allowing the user terminal 300 to display a library expanded to be input for each metadata in the chat room, the library being frequently used in the cultivation device 100 while being included in the cultivation recipe.

In addition, the community management part 230 may allow the user terminal 300 to configure the authenticated user terminal 400 to have a management authority of the cultivation recipe while the expert terminal 400 accessing the chat room inputs consulting data and control data to generate a corrected cultivation recipe.

Here, the community management part 230 causes a correction cultivation recipe to be generated by reflecting expert information, a change history, and a tag based on the consulting data and control data input by the expert terminal 400 so as to allow the user to identify whether the corresponding data is corrected and applied or the like after correction.

In addition, the community managing part 230 may perform a known payment process when the user terminal 300 selects the application of the individual cultivation recipe or the corrected cultivation recipe.

In addition, the community managing part 230 may enable mass production through co-cultivation when the user terminal 300 makes a request together with multiple other user terminals including user terminal 1 300a to user terminal n 300b.

The community managing part 230 may generate and manage a chat room for a cultivation recipe community according to a request of the expert terminal 400, which may be used by the expert terminal 400 to invite another predetermined user or expert to exchange information about a cultivation recipe, receive an individual cultivation recipe, or share a cultivation recipe and to store a result thereof in the database 240.

To this end, the community managing part 230 may allow the expert terminal 400 to invite a specific user among user terminals so as to share a cultivation recipe thereof or to control a cultivation device managed by the corresponding user through the device managing part 220.

In addition, the community managing part 230 may allow the expert terminal 400 to invite multiple user terminals including the user terminal 300 and user terminal 1 300a to user terminal n 300b and link a cultivation recipe thereof with the cultivation device 100, and cultivation device 1 100a to cultivation device n 100b through the device managing part 220 so as to perform co-cultivation.

In addition, the community managing part 230 may generate a chat room for configuring an expert community, which allows the expert terminal 400 to invite one or more of other expert terminals, like the case of the community configuration example of the user terminal 300.

In addition, the community managing part 230 may link a cultivation recipe provided by a predetermined expert terminal (one of 400, 400a, and 400b) from among the expert terminal 400 and expert terminal 1 400a to expert terminal n 400b in the chat room for the expert community with the cultivation device 100 and cultivation device 1 100a to cultivation device n 100b through the device managing part 220 so as to be used for a co-cultivation or joint research purpose.

In addition, the community managing part 230 may perform a known payment process when one of expert terminals 400 participating in the chat room for the expert community selects the application of the cultivation recipe.

The community managing part 230 may generate and manage a chat room for an expert community, which is used for collaboration for optimizing a cultivation algorithm according to a request of the expert terminal 400.

To this end, the community managing part 230 may invite multiple experts to the chat room according to a request of the expert terminal 400. The community managing part 230 displays a cultivation algorithm for each plant crop desired to be optimized posted by a predetermined expert in the chat room.

The community managing part 230 links the cultivation device 100, and cultivation device 1 100a to cultivation device n 100b through the device managing part 220 and manages the chat room to allow each expert to collaborate for optimization of a cultivation algorithm suitable for a purpose of each crop through detailed environment control by each expert with respect to a cultivation algorithm for each plant crop posted by a predetermined expert.

In addition, the community managing part 230 stores a trade history or distribution history after trade or distribution of a recipe is completed. The stored trade history or distribution history may be used as verification data in an event of a conflict between trading or distribution parties.

In addition, the community managing part 230 may automatically generate a chat room for each cultivation device 100. Here, the automatically generated chat room may have sensor data measured by the cultivation device 100 and control data for control, such as video data, audio data, text data, numerical data, and the like, displayed in a chat form.

For example, in the chat room, various control data for automatically controlling the temperature, humidity, CO2, amount of sunlight (LED light amount, wavelength, illumination time, etc.), fertilizer supply amount, irrigation, or the like of the cultivation device 100 may be displayed in a chat form periodically or whenever an event occurs.

The corresponding chat room may be variously changed into a chat room for a cultivation recipe community and a chat room for an expert community by a request of the user terminal 300 or the expert terminal 400 and used.

As such, during an operation of the chat room for the cultivation recipe community and the chat room for the expert community, data measured by the cultivation device 100 and sensor data for control may be displayed periodically or whenever an event occurs.

The database 240 stores authentication information of the member managing part 210, management information of the device managing part 220, and management information of the chat room managing part 230.

The user terminal 300 may access a cultivation recipe community and trade or distribute a cultivation recipe through the cultivation managing platform server 200 as a community application program is executed.

In addition, the user terminal 300 may include a desktop PC, a notebook PC, a tablet PC, a smartphone, a PDA, etc. in which an application such as a community application program may be installed.

Here, the community application program may provide an access path for accessing the cultivation managing platform server 200, control an operation of the cultivation device 100, change and configure a cultivation recipe, allow chatting through a cultivation recipe community, and perform payment for trade and distribution of a cultivation recipe.

In addition, the user terminal 300 may control the cultivation device 100 to operate on the basis of the received cultivation recipe.

In addition, the user terminal 300 may generate a chat room for a cultivation recipe community to invite another predetermined user or expert so as to exchange information about a cultivation recipe, receive an individual cultivation recipe, or perform correction of a cultivation recipe, and store a result thereof in the database 200.

That is, the user terminal 300 may send an invitation message to a specific user, for example, user terminal 1 300a among user terminal 1 300a to user terminal n 300b so as to invite the user to the chat room.

In addition, the user terminal 300 may send an invitation message to one or more experts among the expert terminal 400 and expert terminal 1 400a to expert terminal n 400b to invite the one or more experts to a chat room.

In addition, the user terminal 300 may change a cultivation recipe stored in the cultivation managing platform server 200 to a cultivation recipe of cultivation device 1 100a stored in the cultivation managing platform server 200 based on an approval of user terminal 1 300a and control an operation of the cultivation device 100 by using the changed cultivation recipe.

Here, the individual cultivation recipe stored in the cultivation managing platform server 200 may be configured to be protected through a block chain technology.

In addition, the user terminal 300 may perform a change to a corrected cultivation recipe to which consulting data and control data input from, for example, the expert terminal 400 have been reflected on the basis of the cultivation recipe stored in the cultivation managing platform server 200 and control an operation of the cultivation device 100 by using the changed cultivation recipe.

Here, the user terminal 300 may allow consulting data or control data with respect to values of metadata to be input from the expert terminal 400 by displaying a library expanded to be input for each metadata in the chat room, the library being frequently used in the cultivation device 100 while being included in the cultivation recipe.

Here, the metadata may correspond to data measured by the cultivation device 100 and control data for control, and may include video data, audio data, text data, numerical data, and the like.

The metadata may correspond to, for example, various control data for automatically controlling the temperature, humidity, amount of sunlight, and a fertilizer supply amount, or irrigation of the cultivation device 100.

In addition, the user terminal 300 may configure the authenticated expert terminal 400 to have a management authority of the cultivation recipe while the expert terminal 400 accessing a cultivation recipe community inputs consulting data and control data to generate a corrected cultivation recipe.

Here, the corrected cultivation recipe may be generated by reflecting expert information, a change history, and a tag based on the consulting data and control data to be input so as to allow the user to identify whether the corresponding data is corrected and applied or the like after correction.

In addition, the user terminal 300 may perform a known payment process when the application of the individual cultivation recipe or the corrected cultivation recipe is selected.

Here, the user terminal 300 may enable mass production through co-cultivation by making a request together with multiple other user terminals including user terminal 1 300a to user terminal n 300b.

The expert terminal 400 may correspond to a component to generate a corrected cultivation recipe of a cultivation recipe of the user on the basis of consulting data and control data and may be configured by further including one or more of expert terminal 1 400a to expert terminal n 400b.

Here, an expert for providing the consulting data and control data by using the expert terminal 400 may include a professional cultivation farmer and a cultivation researcher.

Registration of the expert terminal 400 may be performed through registration based on a recommendation of a pre-verified expert, registration based on a recommendation of a public trustworthy institution, or registration based on a high evaluation score through a rating solution of a cultivation recipe community.

In addition, the expert terminal 400 may include a desktop PC, a notebook PC, a tablet PC, a smartphone, a PDA, etc. in which an application, such as a community application program may be installed.

In addition, the expert terminal 400 may generate a chat room for a cultivation recipe community to invite another predetermined user or expert so as to exchange information about a cultivation recipe, receive an individual cultivation recipe, or share a cultivation recipe, and store a result thereof.

In addition, the expert terminal 400 may invite a specific user, for example, user terminal 1 300a among user terminal 1 300a to user terminal n 300b to share a cultivation recipe thereof or control cultivation device 1 100a managed by user terminal 1 300a.

In addition, the expert terminal 400 may invite multiple user terminals including the user terminal 100 and user terminal 1 100a to user terminal n 300b and link a cultivation recipe thereof with the cultivation device 100, and cultivation device 1 100a to cultivation device n 100b through the cultivation managing platform server 200 so as to perform co-cultivation, thereby improving productivity.

In addition, the expert terminal 400 may generate a chat room for configuring an expert community by inviting one or more of other expert terminal 1 400a to expert terminal n 400b, like the case of the community configuration example of the user terminal 100.

In addition, a cultivation recipe provided by a predetermined expert terminal (one of 400, 400a, and 400b) from among the expert terminal 400 and expert terminal 1 400a to expert terminal n 400b in the chat room for the expert community may be linked with the cultivation device 100 and cultivation device 1 100a to cultivation device n 100b through the cultivation managing platform server 200, so as to be used for a co-cultivation or joint research purpose.

Here, a known payment process may be performed when one of expert terminals 400 participating in the chat room for the expert community selects the application of the cultivation recipe.

The expert terminal 400 may generate a chat room for an expert community, which is used for collaboration for optimizing a cultivation algorithm through the community managing part 230.

To this end, the expert terminal 400 may invite multiple experts to the chat room for optimization of the cultivation algorithm.

A predetermined expert terminal (one of 400, 400a, and 400b) among the expert terminal 400 and expert terminal 1 400a to expert terminal n 400b may post a cultivation algorithm for each plant crop to be optimized in the chat room.

The expert terminal 400 and expert terminal 1 400a to expert terminal n 400b may perform a joint operation for the optimization of the cultivation algorithm suitable for a purpose for each crop through detailed environment control by each expert with respect to the cultivation algorithm for each plant crop posted by a predetermined expert terminal (one of 400, 400a, and 400b) in a state in which the cultivation device 100 and cultivation device 1 100a to cultivation device n 400b are linked through the device managing part 220.

Hereinafter, a managing method of a cultivation data managing platform using a dynamic output function according to an embodiment of the present disclosure will be described.

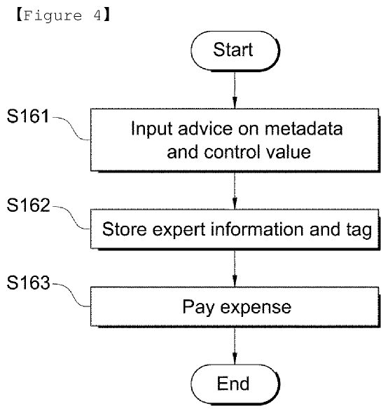

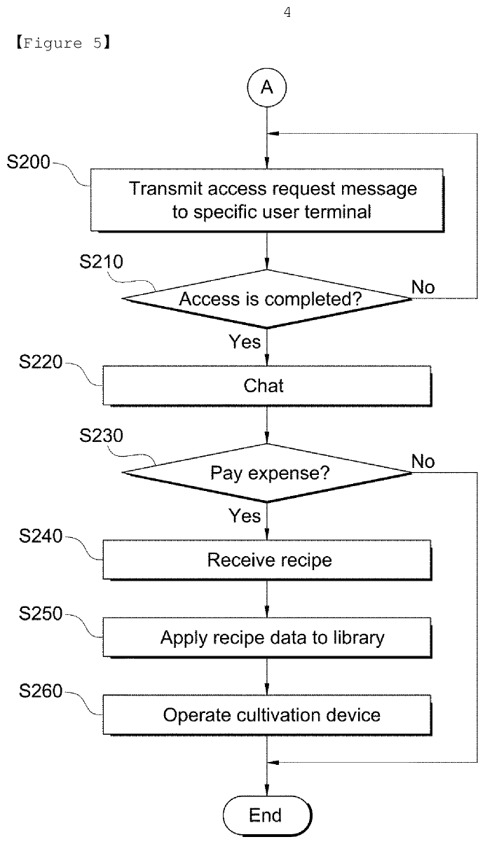

FIG. 3 is a flowchart illustrating a managing method of a cultivation data managing platform using a dynamic output function according to an embodiment of the present disclosure, FIG. 4 is a flowchart illustrating a library modification process by an expert in a managing method of a cultivation data managing platform using a dynamic output function according to the embodiment of FIG. 3, FIG. 5 is a flowchart illustrating a trade process of a plant cultivation recipe in a managing method of a cultivation data managing platform using a dynamic output function according to the embodiment of FIG. 3.

Referring to FIGS. 1 to 5, when an access of the user terminal 300 and the expert terminal 400 through a network is detected, the cultivation managing platform server 200 performs member registration and authentication of a user or member registration and authentication of an expert with the corresponding user terminal 300 or expert terminal 400 (S100).

In addition, in operation S100, the cultivation managing platform server 200 may identify whether the cultivation device 100 is present or not on the basis of member registration information of the user terminal 300 and identify a configuration and a state of the corresponding cultivation device 100.

Thereafter, the cultivation managing platform server 200 searches for a predetermined chat room according to a request of the user terminal 300 or the expert terminal 400 and provides a result thereof, or generates a chat room for a cultivation recipe community linked to the cultivation device 100 according to a request of the user terminal 300 (S110).

In addition, the cultivation managing platform server 200 determines whether an invitation request has occurred for a predetermined expert terminal 400 in the chat room generated in operation S110 (S120), and as the expert invitation request is identified, transmits an invitation message to the corresponding expert terminal 400 (S130).

The cultivation managing platform server 200 determines whether the expert terminal 400 has accessed the chat room (S140), and when the access of the expert terminal 400 is identified, manage a chat between the user terminal 300 and the expert terminal 400 to be started, and the user terminal 300 uploads a previously stored cultivation recipe of the cultivation device 100 to the chat room (S150).

Thereafter, the expert terminal 400 performs correction by inputting predetermined consulting data and control data to the uploaded cultivation recipe (S160).

In operation S160, with respect to the uploaded cultivation recipe, a library frequently used in the cultivation device 100 is expanded to be input for each metadata and consulting data or control data for values of metadata is input from the expert terminal 400 (S161).

Here, the metadata may correspond to data measured by the cultivation device 100 and sensor data for control, and may include video data, audio data, text data, numerical data, and the like.

In addition, while the corrected cultivation recipe of operation S161 is generated, an approved expert terminal 400 may be configured to have an authority for the cultivation recipe.

In addition, the corrected cultivation recipe is stored (S162) by reflecting expert information, a change history, and a tag based on the input consulting data and control data so as to allow the user to identify whether the corresponding data is corrected and applied or the like after correction.

In addition, when the cultivation managing platform server 200 identifies the approval for the corrected cultivation recipe from the user terminal 300 and a payment request is input from the user terminal 300, the cultivation managing platform server 200 performs (S163) expense payment and then manages the corrected cultivation recipe to be traded or distributed. In an embodiment of the present disclosure, it is described as performing an expense request and expense payment, but in another embodiment of the present disclosure, the process of performing a payment request and expense payment may be optional.

Thereafter, the user terminal 300 determines storage of changed data through the expense payment (S170), and as the storage of the changed data is identified through the expense payment, the user terminal 300 reflects the corrected cultivation recipe as a new cultivation recipe of the cultivation device 100, and causes the cultivation device 100 to operate (S180) on the basis of the new cultivation recipe.

Meanwhile, in operation S120, if the invitation is for a specific user rather than multiple experts, the cultivation managing platform server 200 transmits an invitation message to the specific user, for example, user terminal 1 300a (S200). Here, the specific user is referred to as a user who has a preferred cultivation recipe. It may be distinguished from the embodiment in which multiple experts are invited and consulting data or control data with respect to values of metadata regarding the cultivation recipe are received from each expert and preferred consulting data or control data is selected from among the consulting data or control data so as to generate a corrected recipe.

The cultivation managing platform server 200 determines whether user terminal 1 300a accesses the chat room (S210), and when the access of user terminal 1 300a is identified, manages a chat between the user terminal 300 and user terminal 1 300a to be performed (S220).

Subsequently, the cultivation managing platform server 200 determines whether expense payment has been requested from the user terminal 300 (S230).

As the expense payment is requested in operation S230, the cultivation managing platform server 200 performs the expense payment, causes trade of an individual cultivation recipe of the cultivation device 1 managed by the user terminal 1 300a to be performed between the user terminal 300 and user terminal 1 300a, and causes the cultivation device 100 of the user terminal 300 to receive the individual cultivation recipe of cultivation device 1 100a managed by user terminal 1 300a (S240).

The user terminal 300 reflects the individual cultivation recipe of cultivation device 1 100a received in operation S240 as a new cultivation recipe of the cultivation device 100 (S250), and controls the cultivation device 100 to operate on the basis of the new cultivation recipe (S260).

Therefore, it is possible to generate a plant cultivation recipe on the basis of plant cultivation data and control data by using a community application, and trade and distribute the generated plant cultivation recipe.

In addition, it is possible to allow various plant cultivation recipes to be provided, traded, and distributed through activity using a community application so as to expand the distribution of plant cultivation devices.

In addition, it is possible to increase productivity and effective use of the plant cultivation devices through the provision, trade, and distribution of various plant cultivation recipes.

As described above, although it has been described with reference to the preferred embodiments of the present disclosure, those skilled in the art will understand that various modifications and changes may be made to the present disclosure without departing from the spirit and scope of the present disclosure as set forth in the claims below.

In addition, the drawing numbers described in the claims of the present disclosure are only described for clarity and convenience of explanation, without limitation thereto, and in the process of describing the embodiments, the thickness of lines or the size of components shown in the drawings, etc. may be exaggerated for clarity and convenience of description.

In addition, the above-mentioned terms are terms defined in consideration of functions in the present disclosure, which may change according to the intention or custom of the user or operator, so the interpretation of these terms should be made based on the contents throughout the present specification.

In addition, it is obvious that even if it is not explicitly shown or described, those skilled in the art to which the present disclosure pertains may make various modifications including the technical idea of the present disclosure from the description of the present disclosure, and this still falls within the scope of the rights of the present disclosure.

In addition, the above embodiments described with reference to the accompanying drawings are described for the purpose of explaining the present disclosure, and the scope of the present disclosure is not limited to these embodiments.

### BRIEF DESCRIPTION OF REFERENCE NUMERALS

100: Cultivation device
100a: Cultivation device 1
100b: Cultivation device n
200: Cultivation managing platform server
210: Member managing part
220: Device managing part
230: Community managing part
240: Database
300: User terminal
300a: User terminal 1
300b: User terminal n
400: Expert terminal
400a: Expert terminal 1
400b: Expert terminal n

1-21. (canceled)

22. A cultivation data managing platform using a dynamic output function, the cultivation data managing platform comprising a cultivation managing platform server (200) configured to provide a cultivation recipe to a cultivation device (100) configured to develop a cultivation environment and manage a growth state of a plant, and manage an individual recipe generated by a predetermined user using the cultivation device (100), a corrected cultivation recipe to which predetermined consulting data and control data have been reflected, and a plant cultivation algorithm for each crop to be traded or distributed,
wherein the cultivation managing platform server (200):
manages a cultivation recipe or a cultivation algorithm for each crop to be traded or distributed through payment between a user terminal (300) and predetermined user terminal 1 (300a) to user terminal n (300b) or an expert terminal (400);
generates a cultivation recipe or a plant cultivation algorithm for each crop for an entire plant cultivation cycle including a seed management stage, a germination stage, a seedling stage, a stage from planting to harvest, and post-harvest management stage, and continuously manages the generated cultivation recipe or the plant cultivation algorithm for each crop by reflecting a change according to trade or distribution;
when a predetermined cultivation recipe is traded or distributed, controls and manages the cultivation device (100) from a stage in which cultivation starts in the cultivation device (100) to a harvest stage by using the corresponding cultivation recipe; and
synchronizes, in case that a predetermined cultivation recipe or plant cultivation algorithm for each crop is traded or distributed and cultivation is performed in a cultivation device (100), data on the number of days of cultivation in the corresponding cultivation device (100) with cropping schedule from metadata of the traded cultivation recipe or cultivation algorithm so that safe cultivation is performed in the cultivation device (100) for a predetermined period from a time point at which the recipe is traded or distributed or until cultivation is completed even during a cropping season of plant cultivation.

23. The cultivation data managing platform of claim 22, wherein the cultivation managing platform server (200):
shares, when at least one of exchanging information on a cultivation recipe with user terminal 1 (300a) to user terminal n (300b) or the expert terminal (400) invited through the user terminal (300) to a chat room for a cultivation recipe community, receiving a cultivation recipe, and correcting a cultivation recipe is performed, a cultivation recipe to which a result of the performance has been reflected; and
controls the cultivation device (100) to develop a cultivation environment and manage a growth state of a plant according to the cultivation recipe to which the result of the performance has been reflected.

24. The cultivation data managing platform of claim 23, wherein the corrected cultivation recipe is generated by reflecting expert information, a change history, and a tag based on the consulting data and control data input to the expert terminal (400) to allow a user to identify whether the corresponding data is corrected or applied by referring to the expert information, the change history, and the tag.

25. The cultivation data managing platform of claim 24, wherein the cultivation managing platform server (200) comprises a member managing part (210) configured to manage authentication information of the user using the cultivation device (100) and authentication information of an expert using the expert terminal (400) configured to generate the corrected cultivation recipe, and
the member managing part (210) configures, while consulting data and control data are input by the expert terminal (400) approved for a predetermined cultivation recipe, the corresponding expert terminal (400) to have management authority for the cultivation recipe.

26. The cultivation data managing platform of claim 25, wherein the cultivation managing platform server (200) enables, when the user terminal (300) makes a request together with multiple other user terminals including user terminal 1 (300a) to user terminal n (300b) through a chat room, the cultivation device (100), the cultivation device 1 (100a) to the cultivation device n (100b) are co-cultivated in cooperation.

27. The cultivation data managing platform of claim 25, wherein the cultivation managing platform server (200) manages the expert terminal (400) to invite a specific user among user terminals to a chat room generated for a community and shares a cultivation recipe thereof according to consulting or controls a cultivation device managed by the corresponding user terminal.

28. The cultivation data managing platform of claim 25, wherein the cultivation managing platform server (200) allows the expert terminal (400) to invite multiple user terminals including the user terminal (100) and user terminal 1 (100a) to user terminal n (300b) to a chat room generated by a community managing part (230) and links a cultivation recipe thereof with the cultivation device (100), and cultivation device 1 (100a) to cultivation device n (100b) so as to perform co-cultivation.

29. The cultivation data managing platform of claim 25, wherein the cultivation managing platform server (200) links a cultivation recipe provided by a predetermined expert terminal (one of 400, 400a, and 400b) from among the expert terminal (400) and expert terminal 1 (400a) to expert terminal n (400b) in a chat room generated for a community with the cultivation device (100) and cultivation device 1 (100a) to cultivation device n (100b) so as to be used for a co-cultivation or joint research purpose.

30. The cultivation data managing platform of claim 29, wherein the cultivation managing platform server (200) performs optimization of the cultivation algorithm by using collaboration of experts through a chat room generated for a community and manages the optimized cultivation algorithm.

31. The cultivation data managing platform of claim 30, wherein the cultivation managing platform server (200):
links the cultivation device (100), and cultivation device 1 (100a) to cultivation device n (100b); and
manages each expert to collaborate to perform optimization of a cultivation algorithm suitable for a purpose of each crop through environment control with respect to a plant cultivation algorithm for each crop posted in a chat room by a predetermined expert.

32. The cultivation data managing platform of claim 22, wherein the cultivation managing platform server (200) stores, through a blockchain method, a cultivation recipe acquired by the user terminal (300) through payment and a plant cultivation algorithm for each crop, which generates a changed cultivation recipe by actively responding to a variable through a dynamic output function characteristic that dynamically changes according to an input variable including a surrounding situation and environment.

33. The cultivation data managing platform of claim 22, wherein the user terminal (300) controls an operation of the cultivation device (100) and controls the cultivation device (100) to operate on the basis of a cultivation recipe received through payment from user terminal 1 (300a) to user terminal n (300b) or the expert terminal (400), and
the expert terminal (400) analyzes, when recommendation based on a score acquired by being evaluated through a rating solution from a predetermined verified expert, institution, and cultivation recipe community is provided and the payment of the user terminal (300) is completed, a cultivation recipe of the cultivation device (100) to generate a corrected cultivation recipe comprising consulting data and control data.

34. The cultivation data managing platform of claim 23, wherein the cultivation managing platform server (200) enables sensor data measured by the cultivation device (100) and control data for control to be periodically displayed or to be displayed whenever an event occurs, in a chat room which corresponds to a chat room automatically generated for each cultivation device (100).

35. The cultivation data managing platform of claim 34, wherein the automatically generated chat room is configured to enable inviting a predetermined user or expert according to a request of the user terminal (300) or the expert terminal (400).

36. A cultivation device using a dynamic output function and developing a cultivation environment and manage a growth state of a plant,
wherein the cultivation device (100):
develops a cultivation environment and manages a growth state of a plant on the basis of a cultivation recipe or a plant cultivation algorithm for each crop generated for an entire plant cultivation cycle including a seed management stage, a germination stage, a seedling stage, a stage from planting to harvest, and post-harvest management stage;
reflects a predetermined cultivation recipe or cultivation algorithm for each crop having been traded or distributed through the user terminal (300) to a change of the generated cultivation recipe or plant cultivation algorithm for each crop and manages same; and
synchronizes, in case that cultivation is performed on the basis of the cultivation recipe or plant cultivation algorithm for each crop to which the change has been reflected, data on the number of days with cropping schedule from metadata of the traded cultivation recipe or cultivation algorithm for each crop so that safe cultivation is performed for a predetermined period from a time point at which the recipe is traded or distributed or until cultivation is completed even during a cropping season of plant cultivation.

37. A managing method of a cultivation data managing platform using a dynamic output function, the method comprising:
a) performing, by a cultivation managing platform server (200), member registration and authentication of a user and an expert accessing through a user terminal (300) configured to control an operation of a cultivation device (100) and an expert terminal (400) configured to generate a corrected cultivation recipe, respectively;
b) managing, by the cultivation managing platform server (200), a cultivation recipe and a cultivation algorithm for each crop to be traded or distributed through payment between a user terminal (300) and predetermined user terminal 1 (300a) to user terminal n (300b) or an expert terminal (400);
c) by the cultivation managing platform server (200), generating a cultivation recipe or a plant cultivation algorithm for each crop for an entire plant cultivation cycle including a seed management stage, a germination stage, a seedling stage, a stage from planting to harvest, and post-harvest management stage, and continuously managing the cultivation device (100) from a stage in which cultivation starts in the cultivation device (100) to a harvest stage by reflecting a change according to trade or distribution to the generated cultivation recipe or plant cultivation algorithm for each crop; and
d) synchronizing, by the cultivation managing platform server (200), in case that a predetermined cultivation recipe or plant cultivation algorithm for each crop is traded or distributed and cultivation is performed in a cultivation device (100), data on the number of days of cultivation in the corresponding cultivation device (100) with cropping schedule from metadata of the traded cultivation recipe or cultivation algorithm so that safe cultivation is performed in the cultivation device (100) for a predetermined period from a time point at which the recipe is traded or distributed or until cultivation is completed even during a cropping season of plant cultivation, and
wherein the expert terminal (400) analyzes, when recommendation based on a score acquired by being evaluated through a rating solution from a predetermined verified expert, institution, and cultivation recipe community is provided and the payment of the user terminal (300) is completed, a cultivation recipe of the cultivation device (100) to generate a corrected cultivation recipe comprising consulting data and control data.
